(19) United States
(12) Patent Application Publication
(10) Pub. No.: US 2008/0184117 A1
(43) Pub. Date: Jul. 31, 2008

(54) METHOD AND SYSTEM OF MEDIA CHANNEL CREATION AND MANAGEMENT

(75) Inventors: Seth Alsbury, Los Angeles, CA (US); Bruce Krysiak, Los Angeles, CA (US); Daniel Wallace, Los Angeles, CA (US)

Correspondence Address: QUINE INTELLECTUAL PROPERTY LAW GROUP, P.C., P O BOX 458, ALAMEDA, CA, 94501, US

(73) Assignee: AwareMedia, Inc. d/b/a/ Panjea, Los Angeles, CA (US)

(21) Appl. No.: 11/669,154

(22) Filed: Jan. 30, 2007

(51) Int. Cl. G06F 3/00

(52) U.S. Cl. 715/719

(57) ABSTRACT

Methods and systems for creation, distribution, and providing advertising in video content over a network or communications medium such as via the Internet.

### COPYRIGHT NOTICE

Pursuant to 37 C.F.R. 1.71(e), Applicants note that a portion of this disclosure contains material that is subject to and for which is claimed copyright protection (such as, but not limited to, source code listings, screen shots, user interfaces, or user instructions, or any other aspects of this submission for which copyright protection is or may be available in any jurisdiction.). The copyright owner has no objection to the facsimile reproduction by anyone of the patent document or patent disclosure, as it appears in the Patent and Trademark Office patent file or records. All other rights are reserved, and all other reproduction, distribution, creation of derivative works based on the contents, public display, and public performance of the application or any part thereof are prohibited by applicable copyright law.

### FIELD OF THE INVENTION

The present invention in various embodiments is directed to business methods and/or logic processing methods and/or related systems to provide users on the Internet or other communication channels with improved video and channel viewing and editing experiences over a communication connection. In specific embodiments, the invention relates to several novel logic methods and/or business methods and/or logic systems that allow an average web user to create, manage, share, and display video content, including content hosted on different video hosting services. In further embodiments, the invention allows for a user to produce a video channel and select advertising relevant to the video channel and share in advertising revenue.

### BACKGROUND OF THE INVENTION

The discussion of any work, publications, sales, or activity anywhere in this submission, including in any documents submitted with this application, shall not be taken as an admission that any such work constitutes prior art. The discussion of any activity, work, or publication herein is not an admission that such activity, work, or publication existed or was known in any particular jurisdiction.

### SUMMARY

According to specific embodiments, the present invention is involved with business methods and/or logic processing methods and/or systems and/or devices that can be used together or independently to provide a variety of different services and/or experiences related to producing, managing, sharing, annotating video and other media content. In specific embodiments, the invention can be understood as involving new business methods related to video hosting, channel creation, channel hosting, and advertising sharing.

In further embodiments, the invention can be understood as involved with systems and methods that can be used by a back end channel indexer or organizer to enable new ways of creating and experiencing video clips on the internet and new ways to share revenues.

In particular embodiments, the invention involves a system (e.g., a system referred to at times herein as The Pangea Channel Creator™ or Panjea TV™ or Panjea™) that allows users to create media channels including video, video clips, audio, text, and other media, from a variety of different sources on the internet and combine them into a cohesive viewer experience.

Various embodiments of the present invention provide methods and/or systems for media content editing and sharing over a communications network. According to specific embodiments of the invention, a client system is provided with a set of interfaces that allow a user to perform the various video organizing, editing, and managing tasks described herein. The client system displays information indicating various video editing and managing options and displays an indication of an action that a user is to perform to request various actions. In response to a user input, the client system sends to a server system the necessary information to access logic modules and any associated channel data. The server system uses the request data, and optionally one or more sets of server data, to process the request. According to specific embodiments of the present invention, a client system is, or has previously been, provided with an executable code file that allows the client system to receive the data.

### Software Implementations

Various embodiments of the present invention provide methods and/or systems for video and media channels that can be implemented on a general purpose or special purpose information handling appliance using a suitable programming language such as Java, C++, Cobol, C, Pascal, Fortran, PL1, LISP, assembly, etc., and any suitable data or formatting specifications, such as HTML, XML, dHTML, TIFF, JPEG, tab-delimited text, binary, etc. In the interest of clarity, not all features of an actual implementation are described in this specification. It will be understood that in the development of any such actual implementation (as in any software development project), numerous implementation-specific decisions must be made to achieve the developers' specific goals and subgoals, such as compliance with system-related and/or business-related constraints, which will vary from one implementation to another. Moreover, it will be appreciated that such a development effort might be complex and time-consuming, but would nevertheless be a routine undertaking of software engineering for those of ordinary skill having the benefit of this disclosure.

### Other Features & Benefits

The invention and various specific aspects and embodiments will be better understood with reference to the following drawings and detailed descriptions. For purposes of clarity, this discussion refers to devices, methods, and concepts in terms of specific examples. However, the invention and aspects thereof may have applications to a variety of types of devices and systems. It is therefore intended that the invention not be limited except as provided in the attached claims and equivalents.

Furthermore, it is well known in the art that systems and methods such as described herein can include a variety of different components and different functions in a modular fashion. Different embodiments of the invention can include different mixtures of elements and functions and may group various functions as parts of various elements. For purposes of clarity, the invention is described in terms of systems that include many different innovative components and innovative combinations of innovative components and known components. No inference should be taken to limit the invention to combinations containing all of the innovative components listed in any illustrative embodiment in this specification.

In some of the drawings and detailed descriptions below, the present invention is described in terms of the important independent embodiment of a system operating on a digital data network. This should not be taken to limit the invention, which, using the teachings provided herein, can be applied to other situations, such as cable television networks, wireless networks, mobile or video telephone networks, etc. Furthermore, in some aspects, the present invention is described in terms of client/server systems. A number of computing systems and computing architectures are described in the art as client/server art. For the purposes of this description, client/server should be understood to include any architecture or configuration wherein an element acting as a client accesses a remote and/or separate program or device that is providing the desired service (e.g., a server).

All references, publications, patents, and patent applications cited herein are hereby incorporated by reference in their entirety for all purposes.

### BRIEF DESCRIPTION OF THE DRAWINGS

FIG. 1A-B illustrate an example graphical user interface showing a channel surfer/player/browser according to specific embodiments of the present invention.

FIG. 2 illustrates an example channel player showing viral marketing buttons according to specific embodiments of the present invention.

FIG. 3A-C illustrate an example graphical user interface showing various aspects of a channel creator (or builder) according to specific embodiments of the present invention.

FIG. 4 is a block diagram showing a representative example logic device in which various aspects of the present invention may be embodied.

### DESCRIPTION OF SPECIFIC EMBODIMENTS

Before describing the present invention in detail, it is to be understood that this invention is not limited to particular methods or systems, which can, of course, vary. It is also to be understood that the terminology used herein is for the purpose of describing particular embodiments only, and is not intended to be limiting. As used in this specification and the appended claims, the singular forms “a”, “an” and “the” include plural referents unless the content and context clearly dictates otherwise. Thus, for example, reference to “a device” includes a combination of two or more such devices, and the like.

Unless defined otherwise, technical terms used herein have meanings as commonly understood by one of ordinary skill in the art to which the invention pertains. Although any methods and materials similar or equivalent to those described herein can be used in practice or for testing of the present invention, the preferred materials and methods are described herein.

### 1. Glossary

In describing and claiming the present invention, the following terminology will be used in accordance with the definitions set out below.

The term members as used herein should be understood to encompass persons or entities who have signed up, or registered, to become a member of a channel hosting community according to specific embodiments of the invention. By registering, members may be provided with a unique username and password that gives them access to develop for example a profile page, upload video, audio and photography, and to create channels using methods and systems as described herein.

A profile page is a customizable page which is unique to a specific member. The member can, with a combination of external and supplied tools, customize the page with their own text, video, photography and audio clips. A profile page can also contain links to other members.

A channel builder as used herein is a group of technologies according to specific embodiments of the invention that allow members to create sequences of video from clips they have uploaded or found at various sites across the Internet. The clips may be hosted from a variety of video hosting sites. The member can control the sequence of videos that are played as well as the look and feel of the channel player where the videos are displayed for viewers. A specific example implementation according to specific embodiments of the invention is referred to as the Panjea Channel Builder™.

A channel player as used herein indicates a software system generally designed to play a specific channel by a member. According to specific embodiments of the invention, the channel player can be displayed within a custom hosted interface or it can be played, by the insertion of custom JavaScript or similar technology, in any website. Generally, the video content would still be served by the original video hosting source.

### 2. Overview

According to specific embodiments of the invention, the invention provides data processing systems and/or methods and/or business methods that can be used together to provide the benefits described herein. The invention in various embodiments and some of the benefits and features of embodiments of the invention can be understood as described generally below.

### 3. Specific Embodiment Features

Many novel features can be incorporated into specific embodiments of the invention. The features listed below will not be present in all embodiments. The features/functions described below are supported across multiple computing platforms, operating systems, and multimedia input devices, including mobile devices.

### Channel Player

According to specific embodiments of the invention, a channel player interface or suite of logic modules are provided to allow a viewer to view media. In specific embodiments, the invention provides a novel player capable of playing channels of media hosted at multiple sites through a unified viewing interface. In specific embodiments, a channel player can contain advertisements served by a central channel server or advertising server and selected by the channel producer and/or by the channel server. In specific embodiments, a smaller version of a channel player can be embedded in any website the channel producer operates and designates, such as his/her own website, blog, or MySpace profile page. In specific embodiments, this miniature player launches a full-featured channel player in a new browser or (pop-up) window.

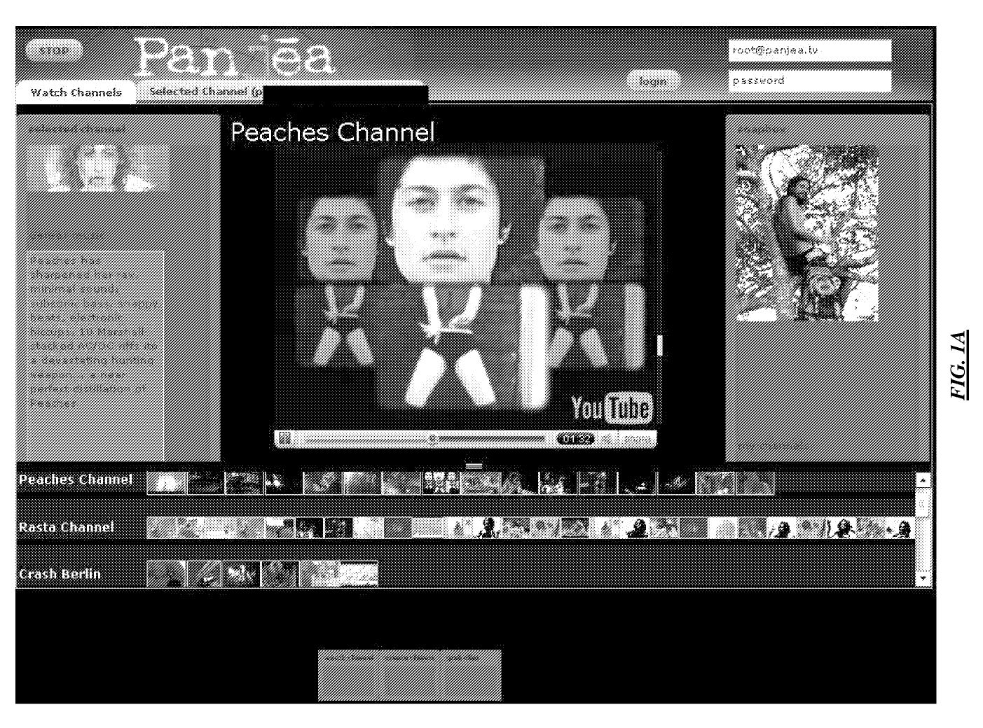

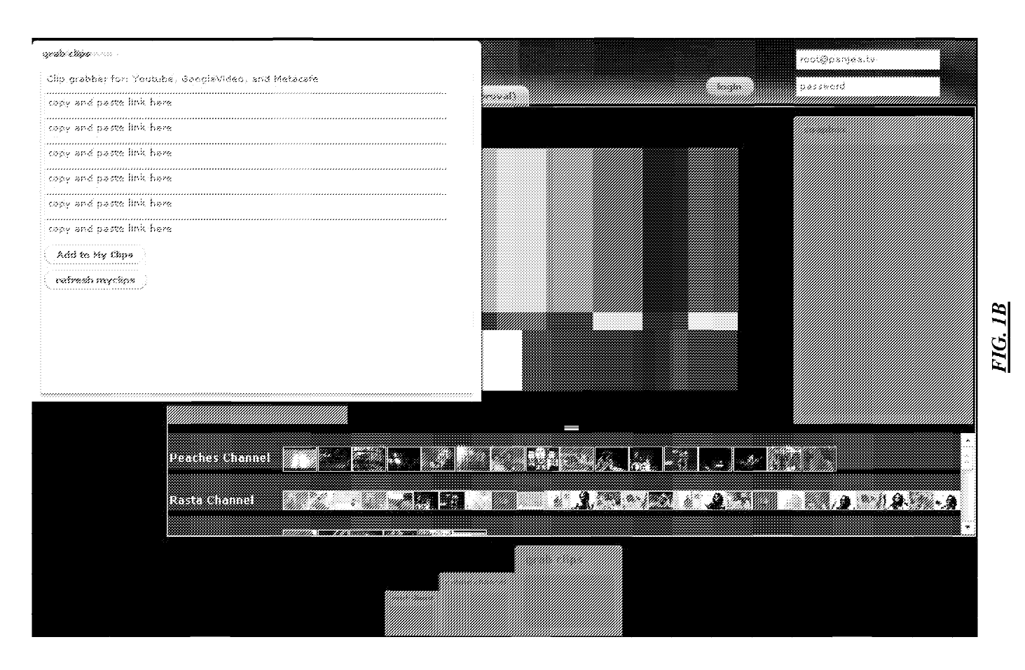

FIG. 1A-B illustrate an example graphical user interface showing a channel surfer/player/browser according to specific embodiments of the present invention. This particular example interface shows a number of useful aspects according to specific embodiments of the invention. In this example, near the bottom of the screen is a channel browse region. This region displays the name of a number of channel, and in this example a horizontal row of small thumbnails indicating the media to be played in sequence in each channel. In this example, the thumbnails are active for each channel and a viewer can select any clip and start playing a channel at that location. A scroll bar to the right of the thumbnail sequences allows scrolling and down a list of channels, each displaying a name and thumbnail sequence as would be understood in the art. The scroll region can be expanded during use, either by a user specifically selecting and expanded option or when no video or channel has been selected to be played.

Above the channel browse region in the center is a player frame. In this example, a YouTube clip is playing with an indicator that the player is hosted from YouTube. This is entirely optional, and video content from any server and using any player can be displayed. Player controls are optionally provided on the player window.

On either site of the player frame in this example are shown optional frames. A number of different optional frames can be shown, some of which are described herein. In this embodiment, an optional information frame is shown to the left of the player frame and an optional chat or blog frame is shown to the right.

In this particular example, at the bottom, the channel browser displays three active buttons: Create Channel; Watch Channel; and Grab Clips. FIG. 1B shows activation of the grap clips button, which allows a user to add clips to his channel as desired.

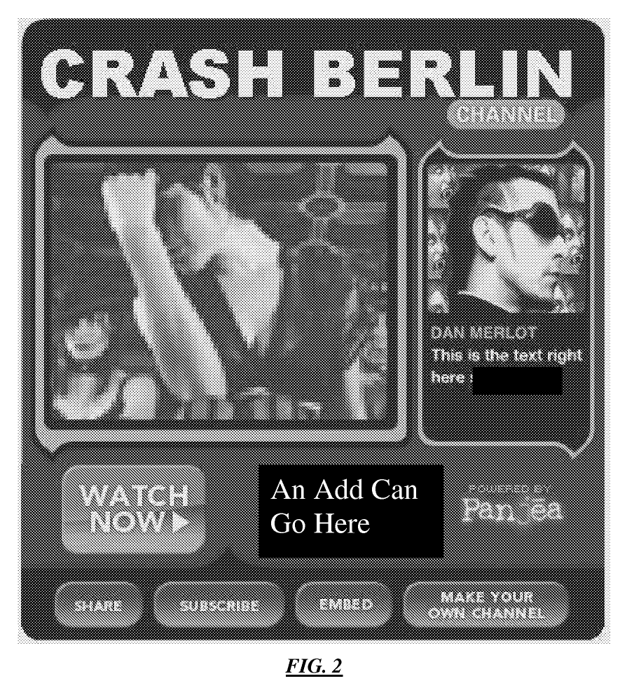

According to specific embodiments of the invention, a channel player includes one or more “viral” marketing drivers to the player as indicated by the buttons at bottom of the example player shown. Examples are: (1) Share Channel, (2) Subscribe (3) Embed Channel, (4) Create Your Own Channel (5) Send Message to Channel Owner. FIG. 2 illustrates an example channel player showing viral marketing buttons according to specific embodiments of the present invention. This example shows a reduced sized channel player that is suitable for embedding at any web location.

### Easy Channel Builder

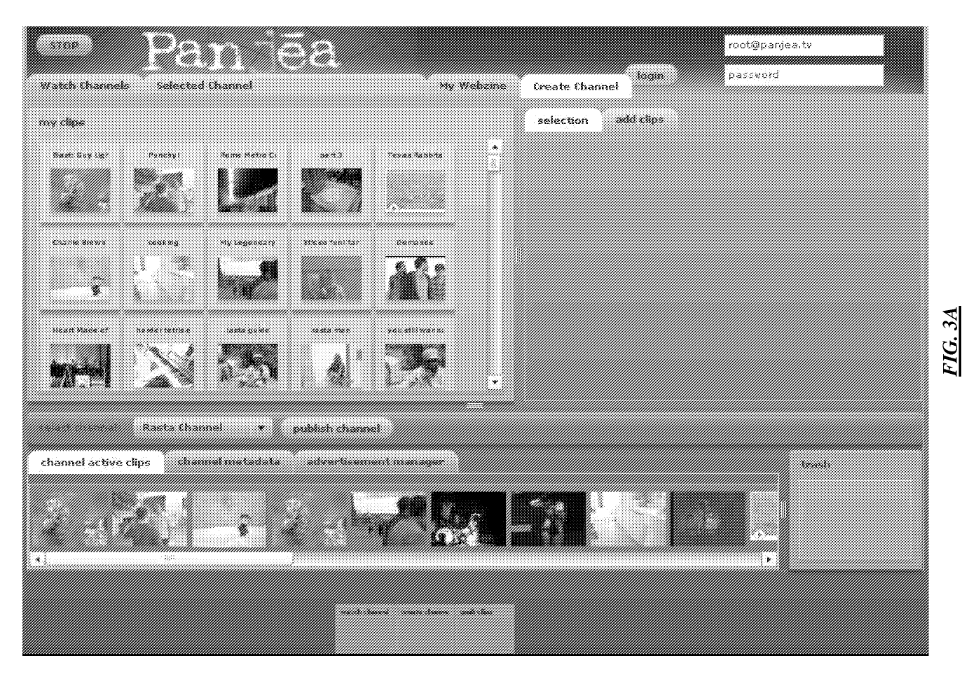

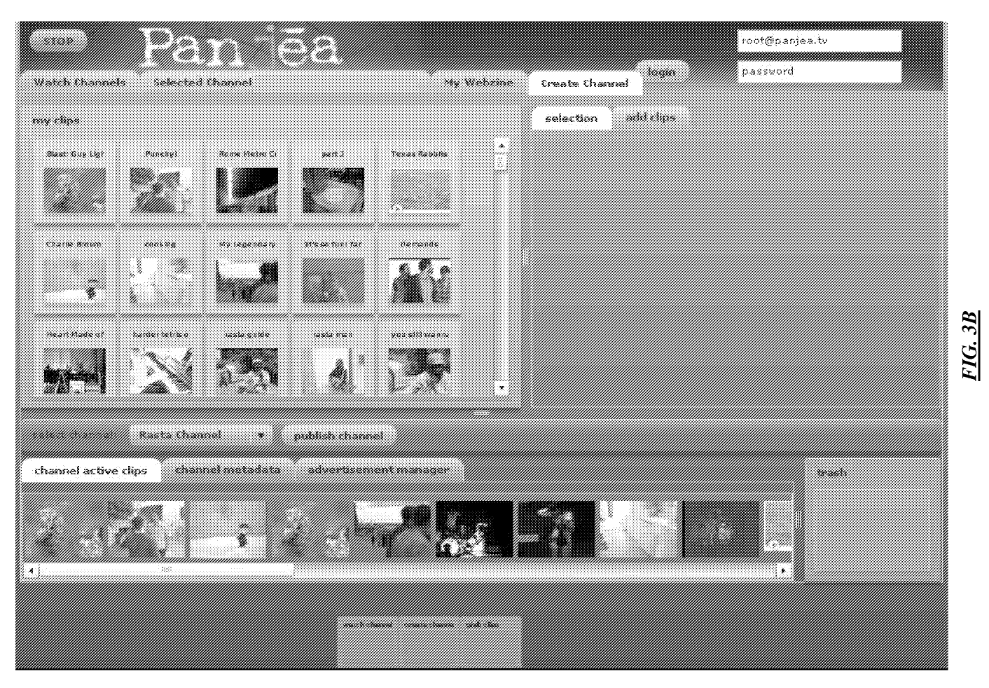

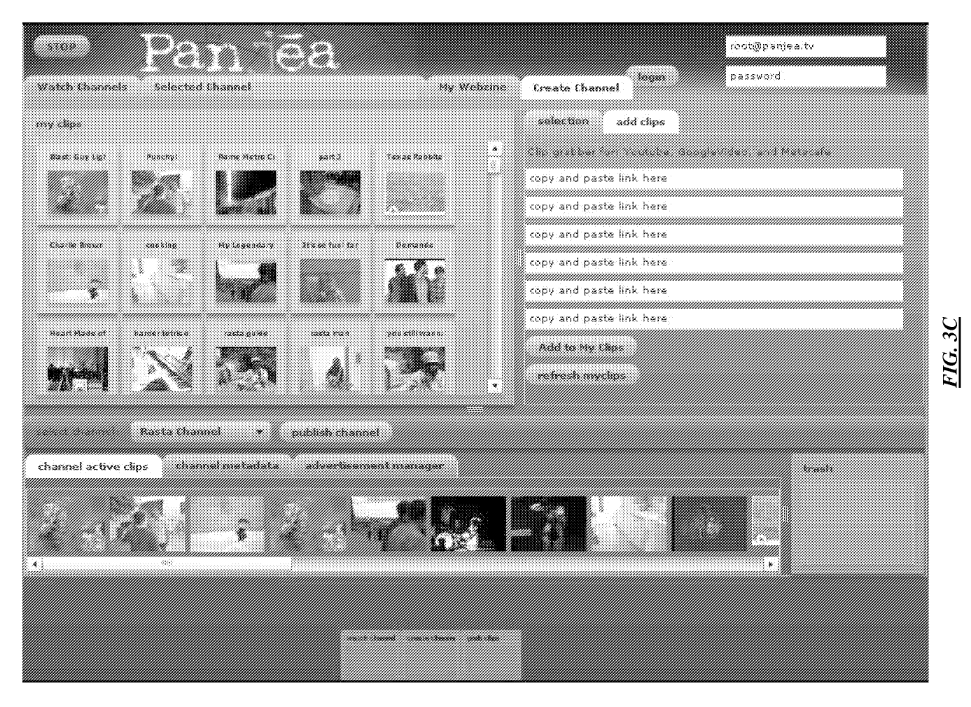

The Easy Channel Builder is a graphical interface driven logic module that includes a number of features making it easy to assemble channels. FIG. 3A-C illustrate an example graphical user interface showing various aspects of a channel creator (or builder) according to specific embodiments of the present invention.

### Content Search

A content search function allows searching across multiple networks and supports multi-media formats, for example by media type, by keyword (tag) description, by popularity, by rating, by genre, by personal network (collaborative filtering).

### Content Grabber

The Content Grabber is a graphical interface driven logic module that includes a number of features making it easy for a user to indicate content to assemble into channels. A content grabber function allows indication of content for including in channels by drag-and-drop, by cut-and-paste, by scraping (e.g., grabbing clips from other URL locations such as blogs, profile pages, etc.). An optional automation feature (applies to content search as well as scraping) includes a scheduling capability.

### Content Uploader

The Content Uploader is a graphical interface driven logic module that includes a number of features making it easy for a user to upload content to a host. This is an optional feature in the case that the channel manager also hosts videos. The uploader supports multiple media formats (e.g., at Panjea.com) and allows indicating content from a users computer or other URL location for example by drag-and-drop or by selecting multiple files.

### Content Manager

The Content Manager is a graphical interface driven logic module that includes a number of features making it easy for a user to manage content uploaded to a host. This is an optional feature in the case that the channel manager also hosts videos. The manager allows managing content by drag-and-drop filing and allows indexing, tagging, sharing.

### Channel Production Studio

According to specific embodiments of the invention, a channel production studio or suite of logic modules are provided to allow users to easily create a more rich channel experience by adding functions or features to a channel in addition to the basic video clip content. Many of the editing functions will be enabled by logic that is stored at a server side system and delivered to a client side as needed. In other embodiments, some or most of the features discussed below can be downloaded to and reside at a client side computer where these components can interact with a channel server as herein described. Among functions available in a Channel Production Studio according to specific embodiments of the invention are those listed below. Not all functions will be present in all embodiments.

Hosting (“VJ”) interface

According to specific embodiments of the invention, a hosting interface or suite of logic modules are provided to allow a user to add video commentary. Commentary can be included in context with content programming. In some embodiments, easy upload-from-webcam widgets or audio modules can be provided for adding commentary (see examples on Widgetbox.com). According to specific embodiments of the invention, a producer can toggle wiki-style viewer-participation in the commentary, thereby letting further users add commentary to some video clips. In various embodiments, this additional commentary can be provided real time or turn-based and can require approval by the producer.

### Media Editing Functions

According to specific embodiments of the invention, an editing interface or suite of logic modules are provided to allow a user to edit media. In specific embodiments, the invention provides a novel means of editing video hosted at multiple sites through a unified editing interface hosted by a channel hoster. Video editing features can include thing such as (1) simple sequencing (drag-and-drop); (2) simple sampling, which allows selecting segments of given media files for example by time markers or visual placement of markers and through a drag-and-drop interface.

In specific embodiments, the invention enables transitions insertion according to various embodiments with various options. Transitions can be inserted before or after content, from a library, or can be user-created. Viewer-participation can also be enabled in transitions according to various embodiments.

According to specific embodiments of the invention, the editing interface allows the producer to select different allowed viewing modes, such as requiring contiguous streaming channel viewing or allowing a user to interactively control the video content. A slide show mode allows a subset of functions such as pause, move forward, move backwards.

In various embodiments, a producer can direct specific viewer's experience such as based on limited inputs from the user or a personalized experience for particular viewers.

In specific embodiments, the invention enables creation of subtitles and/or voiceovers. Subtitles can be overlays or surround the playback frame. Voiceovers can be incorporated into the video that are optional and selectable by the viewer and can be easily recorded from the user's computer. Viewer-participation can also be enabled for subtitles or voiceovers.

### Advertising Manager

According to specific embodiments of the invention, an advertising interface or suite of logic modules are provided to allow a user to select and incorporate advertising into a channel. Ads are supported from multiple affiliate networks, such as Commission Junction; Hydra Media, etc. In particular embodiments, users select ads to appear in, over, and around their content channel(s) and users participate in revenue generated. In specific embodiments, inclusion of some ads may be contingent on approval from advertisers and/or networks.

### Business Model and User Example

Using various of the methods and technologies described above, the present invention provides a system and/or business model that facilitates bringing together creative people and ideas and mixing them up. In specific embodiments, the Panjea model can be considered akin to a mix tape, the essence of which is selecting a group of otherwise unrelated songs and putting them together in a personally more meaningful way. The power is in telling a story, or sharing an experience with another person, be it an individual or audience. The invention enables an ordinary web user to create and share a media experience using video clips or other media they find or upload online.

Thus, in specific embodiments, the invention comprises a set of, easy-to-use online tools which empower anyone to produce their very own branded, personal channel experiences and to share those experiences from any online location they choose.

For example, consider the MySpace profile of a music artist. To share video clips from YouTube with his friends and fans, the artest must do what's called “embedding”, a multi-step process involving cutting and pasting unique URL codes from YouTube, and then hacking the fields of his MySpace profile such that a square “player” appears across his page for each video clip embedded. A time-consuming process which yields less-than-attractive results Using a channel building tool according to specific embodiments of the invention, the music artist can now find and share new video clips with his fans in seconds; not only producing a more compelling TV-like experience for his viewers, but also increasing his exposure to new fans and possibly even generating revenue from advertising sponsors.

Thus, in specific embodiments, the invention enables a branded, customized broadcast experience that can be embedded with one click on anyone's MySpace page, homepage or blog. With the channel model of the current invention, the artist can continually publish new content with a click of his mouse.

In one method of creating a channel, a user can use Panjea's easy video search tool to locate interesting video clips. He then previews then and selects those he likes, and simply drags them into a channel timeline. Specific embodiments of the invention include powerful options for more advanced users, including an ad management tool by which the channel producer can control which advertisements appear in and around his channel. But for the everyday user, it's as simple as point and click, drag and drop. Thus the invention provides a personal branded channel experience that is easy to build and update and where and ordinary web user can be a channel producer and have full control over the broadcast experience, from the content selection, to the ads that appear around it.

In further embodiments, the invention includes a viral marketing capability by leveraging the brand loyalty or personal affinity of a user watching a particular channel. In particular embodiments, a player includes four buttons that drive viral adoption of the Panjea paradigm. From left to right: Share this channel Sends an email to whoever is designated Subscribe to this channel Notifies a viewer by email everytime a producer publishes new content Embed this channel Generates a unique code that can be easily placed on a viewer's own page, blog, or MySpace page. The embed feature is especially powerful for fans who want to have their favorite artists “present” on their own page. Create your own channel is the gateway to an entirely new behavior of allowing users to share video content by creating a channel with essentially a few mouse selections.

In further embodiments, revenue is generated by allowing sponsorship of a channel, such as the channel of an artist or sports star. From an advertiser's standpoint, the brand can follows the artist right into the virtual homes of his fans due to the easy embedding of channels in other webspaces as the embedded portion of the channel includes the sponsor's information.

### Further User Example

As a further example, consider a grandmother who has a personal page or blog that she shares with friends and family and who wishes to place videos of her six grandchildren (children of her son and two daughters). In the individual video model, the grandmother would have to place individual links to video clips that perhaps are uploaded by each of her children. Each time a new clip of a grandchild is available, the grandmother must embed a new link or player into her blog or web page.

According to specific embodiments of the invention, the grandmother would place a single channel on her webpage and could add video links to it when they become available. This can create a much simpler design of a webpage. Furthermore, using simple rules, such as play the videos in reverse chronological order, the grandmother can keep the video player in one place, add new video clips, and maintain a history of clips.

As a further embodiment, if two of the grandmother's children have one or more channels of her grandchildren, the grandmother can include those channels in her channel. In that instance, when either she or a friend want to view any new video clips, she or the friend can simply look at the player on the grandmother's webpage, and any clips from her children's channels will be playable.

In a further embodiment, a grandmother can set the order of play in her channel, for example, in reverse chronological order, so that video clips from different channels will play on her channel.

In a further embodiment, a player according to specific embodiments of the invention can identify a particular person viewing a webpage (either explicitly by asking the viewer if they wish to logon or implicitly, for example from a cookie or incoming IP address) and play only new clips for that viewer or play only clips that that viewer had indicated are of interest. (If a music critic produced a channel, for example, a particular viewer may indicate they only want to see clips related to a certain genre of music or a certain performer)

### 4. Embodiment in a Programmed Information Appliance

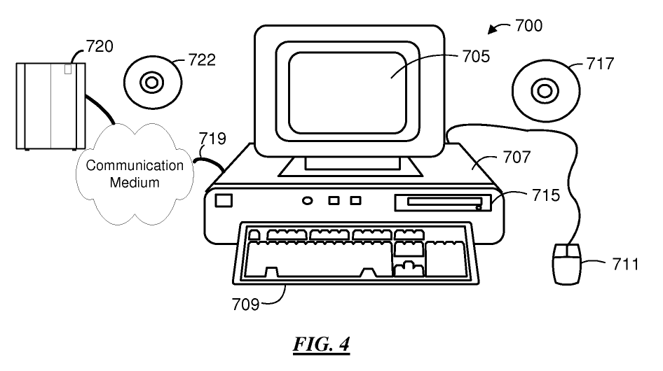

FIG. 4 is a block diagram showing a representative example logic device in which various aspects of the present invention may be embodied. As will be understood to practitioners in the art from the teachings provided herein, the invention can be implemented in hardware and/or software. In some embodiments of the invention, different aspects of the invention can be implemented in either client-side logic or server-side logic. As will be understood in the art, the invention or components thereof may be embodied in a fixed media program component containing logic instructions and/or data that when loaded into an appropriately configured computing device cause that device to perform according to the invention. As will be understood in the art, a fixed media containing logic instructions may be delivered to a user on a fixed media for physically loading into a user's computer or a fixed media containing logic instructions may reside on a remote server that a user accesses through a communication medium in order to download a program component.

FIG. 4 shows an information appliance (or digital device) 700 that may be understood as a logical apparatus that can read instructions from media 717 and/or network port 719, which can optionally be connected to server 720 having fixed media 722. Apparatus 700 can thereafter use those instructions to direct server or client logic, as understood in the art, to embody aspects of the invention. One type of logical apparatus that may embody the invention is a computer system as illustrated in 700, containing CPU 707, optional input devices 709 and 711, disk drives 715 and optional monitor 705. Fixed media 717, or fixed media 722 over port 719, may be used to program such a system and may represent a disk-type optical or magnetic media, magnetic tape, solid state dynamic or static memory, etc.. In specific embodiments, the invention may be embodied in whole or in part as software recorded on this fixed media. Communication port 719 may also be used to initially receive instructions that are used to program such a system and may represent any type of communication connection.

The invention also may be embodied in whole or in part within the circuitry of an application specific integrated circuit (ASIC) or a programmable logic device (PLD). In such a case, the invention may be embodied in a computer understandable descriptor language, which may be used to create an ASIC, or PLD that operates as herein described.

### 5. Other Embodiments

The invention has now been described with reference to specific embodiments. Other embodiments will be apparent to those of skill in the art. In particular, a user digital information appliance has generally been illustrated as a personal computer. However, the digital computing device is meant to be any information appliance for interacting with a remote data application, and could include such devices as a digitally enabled television, cell phone, personal digital assistant, laboratory or manufacturing equipment, etc. It is understood that the examples and embodiments described herein are for illustrative purposes and that various modifications or changes in light thereof will be suggested by the teachings herein to persons skilled in the art and are to be included within the spirit and purview of this application and scope of the claims.

1. A method allowing a user to create a customized multimedia channel using a graphical web interface, said method comprising:
providing a simple interface allowing a user to point and click and/or drag and drop video content from any available video location;
providing a simple sequencer allowing a user to arrange a sequence of video content and optionally add additional content;
providing a link to embed a channel player into any location that is accessible via a URL; such that said user can mix video content from multiple places on the web into one video stream;
such that said user can embed said channel player at any URL;
wherein when said channel is activated it can be played as a continuous stream of video.

2. The method of claim 1 wherein said any available video location comprises at least two different video hosting services, such as YouTube.com; Veoh.Com; etc.

3. (canceled)

4. The method of claim 3 wherein a video stream in said channel can include videos from multiple channels in a different order than those videos are provided in said multiple channels and can intermingle video clips from different channels into one video stream.

5. The method of claim 4 wherein a video stream in said channel is ordered according to one or more of:
last posted date from multiple channels;
at random from multiple channels.

6. (canceled)

7. The method of claim 4 wherein said channel player is able to identify a particular viewer and present a video stream order customized for that particular viewer.

8. The method of claim 4 wherein said channel player includes one or more of:
controls allowing a viewer to select an order for playing video clips;
links allowing a viewer to select particular clips of said channel.
controls allowing a viewer to add one or more indicated clips or channels to a different channel.

9-10. (canceled)

11. The method of claim 1 further wherein said channel player includes controls and includes one or more areas external to video play for one or more of: branding or sponsorship information; advertisements; descriptions or comments; and links to other content.

12. The method of claim 1 wherein said channel can be easily produced, distributed, monetized by a user with very simple and familiar web commands.

13-15. (canceled)

16. The method of claim 1 wherein said user can optionally and selectively include advertisements either between video clips or around a video space thereby allowing a user to tailor advertisements most likely to be of interest to viewers of said channel and wherein a host of said channel information shares advertising revenue generated by said user's channel.

17-18. (canceled)

19. The method of claim 1 further comprising:
providing a grabbing tool allowing a user authorized to modify content an indicated or active URL to:
collect any embedded or linked video at said URL into one or more channels;
add a channel player at said indicated URL's if one is not present;
remove separately embedded video players from said URL that have been added to said channel;
thereby reducing the amount of visual space at a URL that is devoted to linking to video content.

20. The method of claim 1 further comprising:
providing an easy channel builder with enable a user to perform the following:
content search; content grabber; content uploader; content manager; channel production studio; ad manager; and further wherein
said content search allows a user to search for content across multiple networks and/or video hosting services;
said content search supports different media formats for audio, video, still image and other media;
said content search allows a user to search by media type;
said content search allows a user to search by keyword (tag) description.
said content search allows a user to search by one or more of: popularity; rating; genre.
said content search allows a user to search by personal network to enable collaborative filtering.

21-26. (canceled)

27. The method of claim 20 further wherein said content grabber allows a user to indicate content by one or more of:
by drag-and-drop;
by cut-and-paste;
by scraping content from other web locations such as blogs, profile pages, etc.

28. The method of claim 20 further wherein said content grabber allows a user to indicate criteria for automatic searching and scraping where the criteria include a scheduling capability.

29. The method of claim 20 further wherein said content uploader supports multiple media formats, allows a user to indicate media for upload using drag-and-drop and multi-selection of files.

30. (canceled)

31. The method of claim 20 further wherein said channel production studio comprises:
a broadcaster hosting (“VJ”) interface allowing a user to add video commentary selectively in context with content programming.

32. The method of claim 20 further wherein said channel production studio comprises:
an interface allowing a user to upload commentary selectively using an easy upload-from-a webcam such as a webcam widget (see examples on Widgetbox.com);
an interface allowing a user to selective allow wiki-style viewer-participation, optionally with selections allowing scheduling viewer participation; and further providing a user with the ability to selectively perform one or more of the following:
simply sequence video clips using drag-and-drop.
simply sample from video content by selecting segments of given media files using one or more of visual placement of time markers or drag-and-drop placement of clip markers;
insert transitions before or after content and transitions that are from a public or personal library or user-created;
select whether viewers can view a channel only as a continuous stream or by interactively selecting video content;
select whether viewers can view a channel in a slide show mode;
select a viewing experience either based on inputs or based on defaults personalized for an identified user.
create subtitles as overlays or surrounding a playback frame;
create voiceovers and allows a viewer to toggle mute audio track on video playback or overdub;
include advertisements from multiple affiliate networks, such as Commission Junction;
Hydra Media, etc.;
select ads to appear in, over, and around their content channel(s).

33-42. (canceled)

43. The method of claim 20 further wherein said ad manager communicates with a server interface to track displayed and/or clicked-through ads and allows said user to participate in any advertising revenue generated.

44. (canceled)

45. The method of claim 19 further comprising:
placing or leaving a reduced size link to video content at locations at said URL where a separate player has been removed and further wherein said reduced size link may be selected from one or more of:
a text link;
a graphics link;
a link that activates a separate player;
a link that activates said channel player and begins playing said continuous video stream at the point in the stream of the removed content.

46. (canceled)

47. A system for managing video content available at a variety of URLs comprising:
a channel builder;
a channel player;
a channel surfer;
a grabbing tool;
one or more channel editing tools;
one or more advertising selecting tools.

48. A computer readable medium containing computer interpretable instructions describing a circuit layout for an integrated circuit that, when constructed according to said descriptions, will configure a circuit to embody the apparatus described in claim 47.

49. (canceled)
